(19) United States
(12) Patent Application Publication
(10) Pub. No.: US 2024/0361101 A1
(43) Pub. Date: Oct. 31, 2024

(54) SIGHT SYSTEM

(71) Applicant: Lead & Steel LLC, Plain City, OH (US)

(72) Inventor: Mohammad Aboukar, Dublin, OH (US)

(21) Appl. No.: 18/645,148

(22) Filed: Apr. 24, 2024

Related U.S. Application Data
(60) Provisional application No. 63/498,264, filed on Apr. 25, 2023.

(51) Int. Cl. F41G 1/30; F41G 3/08; G02B 27/34; G02B 27/36

(52) U.S. Cl. CPC F41G 1/30; F41G 3/08; G02B 27/34; G02B 27/36

(57) ABSTRACT

A sight system for a firearm or like device can comprise a housing; a lens coupled to the housing; a power source disposed in the housing; a switch in electronic communication with the power source; an emitter system disposed in the housing and in electronic communication with the switch; and/or a motion sensor. The emitter system can comprise a first emitter configured to present a primary reticle visible via the lens, and/or a second emitter configured to present a secondary reticle visible via the lens. The motion sensor can be in electronic communication with the second emitter. The first emitter and the second emitter can be electronically in parallel with one another. In response to a predetermined nonmovement duration passing without the motion sensor detecting movement, the sight system can be configured to disable the second emitter and maintain the first emitter to continue to present the primary reticle.

### CROSS-REFERENCE TO RELATED APPLICATIONS

This application is a nonprovisional of, and claims priority to and the benefit of, U.S. Provisional Patent Application No. 63/498,264, filed Apr. 25, 2023 and entitled “METHOD TO PARTIALLY DISABLE AIMING RETICLE,” which is hereby incorporated by reference herein.

### BACKGROUND

Reflector or holographic sights (or other electronic sight system) for firearms and other like devices can facilitate target acquisition and shot placement by a user. A reflector sight employs an illuminated image (e.g., a reticle) reflected from a lens along an axis, such that the illuminated image can be used as an aiming point for the user. A holographic sight employs light to illuminate a holographic reticle through a lens for viewing by the user. However, such sights require a power source (e.g., a battery) to provide the illuminated reticle, thus there is a risk of the power supply depleting and leaving the user without the desired aiming system. Also, completely turning off a reflective or holographic sight (or other electronic sight system) to conserve power has the disadvantage of failing to be battle-ready in the event of an urgent need for the firearm and sight system.

### SUMMARY

Disclosed is a sight system for a firearm or like device. A sight system can comprise a housing; a lens coupled to the housing; a power source disposed at least partially in the housing; a switch in electronic communication with the power source; an emitter system disposed at least partially within the housing and in electronic communication with the switch; and/or a motion sensor. The emitter system can comprise a first emitter configured to present a primary reticle visible via the lens; and/or a second emitter configured to present a secondary reticle visible via the lens. The first emitter and the second emitter can be electronically in parallel with one another. The motion sensor can be electronically coupled with the second emitter. In response to a predetermined nonmovement duration passing without the motion sensor detecting movement, the sight system can be configured to disable the second emitter and maintain the first emitter to continue to present the primary reticle. The sight system can further comprise an emitter tray in which the emitter system is disposed within the housing. The sight system can further comprise a windage adjustment screw coupled to the emitter tray; and/or an elevation adjustment screw coupled to the emitter tray. In response to moving the windage adjustment screw, the emitter tray can move along a first axis. In response to moving the elevation screw, the emitter tray can move along a second axis that is substantially perpendicular to the first axis.

The emitter system can comprise a plurality of reticle configurations including: a complete reticle configuration comprising the primary reticle and the secondary reticle visible via the lens; a primary reticle configuration comprising the primary reticle visible via the lens without the secondary reticle; and/or a secondary reticle configuration comprising the secondary reticle visible via the lens without the primary reticle. The switch can comprise a first input device and a second input device. In various examples, in response to the first input device and the second input device being activated at the same time, the sight system can be configured to change from one reticle configuration to another reticle configuration of the plurality of reticle configurations.

A system, method, and article of manufacture (collectively, “the system”) are disclosed relating to a sight system for a firearm or like device. In various examples, the system can comprise a lens and an emitter system comprising a first emitter configured to present a primary reticle via the lens, and/or a second emitter configured to present a secondary reticle via the lens; a motion sensor electronically coupled to the second emitter; a processor operably connected to the first emitter, the second emitter, and/or the motion sensor; and/or a tangible non-transitory computer readable memory configured to communicate with the processor, the tangible non-transitory computer readable memory having instructions stored thereon that, in response to execution by the processor causes the processor to perform operations. The first emitter and the second emitter can be electronically in parallel with one another. The motion sensor can be electronically in series with the second emitter and/or electronically in parallel with the first emitter. The primary reticle can be a dot reticle and the secondary reticle can be a perimeter reticle configured to at least partially surround the dot reticle. The system can comprise a switch in electrical communication with the emitter system. The switch can comprise a first button and a second button.

The system can be configured to perform operations including enabling, by the processor, the first emitter and the second emitter such that the primary reticle and the secondary reticle are visible via the lens; starting, by the processor, a timer for a predetermined nonmovement duration; detecting, by the processor and the motion sensor, a lack of motion for the predetermined nonmovement duration; and/or in response to detecting the lack of motion, disabling, by the processor, first emitter such that the primary reticle is not presented or the second emitter such that the secondary reticle is not presented. The operations can further comprise maintaining, by the processor, an emission from the other of the first emitter and the second emitter. The operations can further comprise detecting, by the processor and the motion sensor, a movement; and/or in response to detecting the movement, enabling, by the processor, the disabled emitter such that both the primary reticle and the secondary reticle are visible via the lens. The operations can further comprise, prior to detecting a lack of motion, detecting, by the processor and the motion sensor, a movement within the predetermined nonmovement duration; and/or restarting, by the processor, the timer for the predetermined nonmovement duration in response to detecting the movement.

In various examples, the operations can further comprise detecting, by the processor, the first button and the second button being pressed at the same time; and/or, in response, changing, by the processor, a reticle configuration produced by the emitter system. A plurality of reticle configurations can comprise a complete reticle configuration comprising the primary reticle and the secondary reticle visible via the lens; a primary reticle configuration comprising the primary reticle visible via the lens without the secondary reticle; and/or a secondary reticle configuration comprising the secondary reticle visible via the lens without the primary reticle. In response to a complete reticle configuration being emitted and detecting the first button and the second button being pressed at the same time, the operations can further comprise disabling, by the processor, the first emitter such that the primary reticle is not presented or the second emitter such that the secondary reticle is not presented.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures. Elements with like element numbering throughout the figures are intended to be the same.

FIG. 1A illustrates a schematic diagram of a firearm and sight system, in accordance with various examples.

FIG. 1B illustrates a schematic diagram of a sight system, in accordance with various examples.

FIG. 2A illustrates an aft perspective view of a sight system, in accordance with various examples.

FIG. 2B illustrates a front perspective view of the sight system of FIG. 2A, in accordance with various examples.

FIG. 2C illustrates a front view of the sight system of FIG. 2A, in accordance with various examples.

FIG. 2D illustrates a cross-sectional side view of the sight system of FIG. 2C along line A-A, in accordance with various examples.

FIG. 2E illustrates a side view and a cross-sectional front view along line B-B of the sight system of FIG. 2A, in accordance with various examples.

FIG. 3A illustrates a front perspective view of various components of the sight system of FIG. 2A, in accordance with various examples.

FIG. 3B illustrates an aft perspective view of various components of the sight system of FIG. 2A, in accordance with various examples.

FIG. 4 illustrates a bottom perspective view of various components of FIG. 3B disposed in a housing of the sight system of FIG. 2A, in accordance with various examples.

FIG. 5 illustrates a method of reticle presentation of a sight system, in accordance with various examples.

FIG. 6 illustrates a method of changing a reticle of a sight system, in accordance with various examples.

### DETAILED DESCRIPTION

The detailed description of various examples herein refers to the accompanying drawings, which show various examples by way of illustration. While these various examples are described in sufficient detail to enable those skilled in the art to practice this disclosure, other examples may be realized and structural, electrical, and/or logical changes may be made without departing from the scope of the disclosure.

As used herein, the term “aft,” “back,” “rear,” or the like refers to the direction associated with a butt (e.g., the back or rear end) of a firearm or the breech of a firearm barrel, or generally, to the direction of recoil in response to firing a round or cartridge in a firearm. As used herein, the term “forward,” “front,” or the like refers to the direction associated with a muzzle (e.g., the front end) of the firearm or barrel, or generally, to the direction of flight of a projectile (e.g., a bullet) fired from a firearm.

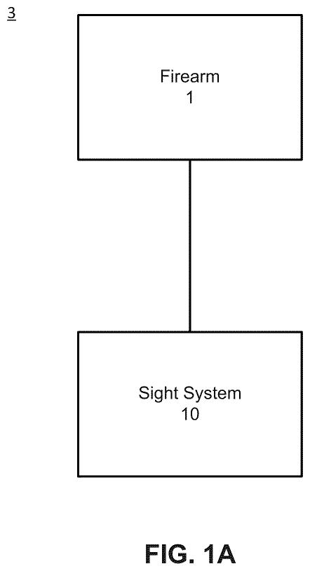

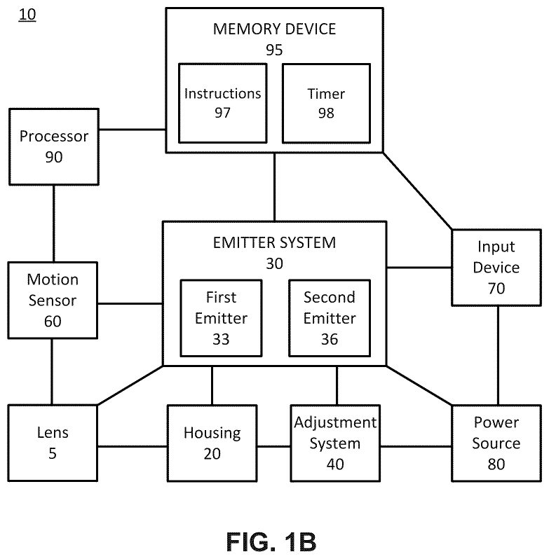

With reference to FIG. 1A, a firearm system 3 can comprise a firearm 1 and an optic or sight system 10 coupled to firearm 1. Sight system 10 can be coupled to firearm 1 in any suitable position or manner. For example, a sight system can be coupled to the receiver of a firearm (e.g., a rifle or other long gun), e.g., on a rail of the receiver. As another example, a sight system can be coupled to a slide of a semiautomatic pistol, such that the sight system protrudes from a top of the slide and moves with the slide when the slide moves forward and aft (e.g., in response to cycling during firing). The sight system can be configured to allow a user to acquire a target and align the user's line of sight with an intended target.

With reference to FIG. 1B, a schematic diagram of a sight system 10 (e.g., an electronic sight system, such as a reflector or holographic sight system) is depicted, in accordance with various examples. Sight system 10 can comprise a housing 20, which can be configured to house, couple to, and/or at least partially enclose other components of sight system 10. For example, housing 20 can comprise a lens 5, an emitter system 30, an adjustment system 40, a motion sensor 60, an input device 70, a power source 80, a controller or processor 90, and/or a memory device 95 disposed at least partially therein and/or coupled thereto.

In various examples, lens 5 can be an optical element configured to reflect, diffract, and/or display an image (e.g., a reticle(s)) that the user can use as an aiming point. The presented image can be emitted from an emitter (e.g., a light, such as a light emitting diode (LED)) onto lens 5 and reflected toward the user. Lens 5 can be a curved mirror or other at least partially reflective element that is at least partially transparent (e.g., transparent glass, polymeric material, and/or the like). A lens, as referred to herein, can be any at least partially transparent component of a sight system through which a user views to aim with, and/or that presents, a reticle or other image to the user thereon and/or therethrough.

In various examples, emitter system 30 can comprise hardware and/or software components (e.g., capable of storing, transmitting, and/or analyzing information). Emitter system 30 can be a system that emits light (e.g., via an in candescent light, LED, laser, laser diode, and/or the like) for viewing by the user. The light emitted can be an image, such as a reticle, or can be used to illuminate a reticle, for example, disposed in lens 5. In various examples, an emitted image can be projected to a lens and reflected from the lens (e.g., lens 5) toward the user for the user to utilize as an aiming point. In other examples, the light can be emitted and directed to lens 5 (e.g., by reflecting from one or more components), thereby illuminating an image (e.g., a reticle(s)). Accordingly, emitter system 30 (or a portion(s) thereof) can be in optical and/or photic communication with lens 5.

Emitter system 30 can comprise one or more emitters (e.g., lights, such as LEDs). Each emitter can emit light to present an image (e.g., a reticle). Each image presented by each emitter can be a separate image. In various examples, each emitter can emit an image (e.g., a reticle). The light emitted by each emitter can be combined into a complete configuration which comprises the light emitted by all emitters in the emitter system, and the respective images presented (e.g., each emitter can emit a reticle, such that a complete reticle configuration comprises the reticle from each emitter in the emitter system for the user to view and utilize). As depicted in sight system 10, emitter system 30 can comprise a first emitter 33 and a second emitter 36. First emitter 33 can emit a primary reticle, and second emitter 36 can emit a secondary reticle (e.g., for a reflector sight). First emitter 33 can emit light that illuminates or presents a primary reticle, and second emitter 36 can emit light that illuminates or presents a secondary reticle (e.g., for a holographic sight). First emitter 33 and second emitter 36 can be in optical and/or photic communication with lens 5.

In various examples, adjustment system 40 can be coupled to and/or at least partially disposed in housing 20 of sight system 10. Adjustment system 40 can be configured to adjust the position of the image(s) presented to the user via emitter system 30 and/or lens 5. That is, to sight in sight system 10 (such that a projectile fired from the firearm coupled to sight system 10 will impact a desired point relative to the position of a reticle), the user can adjust the position of emitter system 30 (or the light or LED therein). Adjustment system 40 can allow for windage adjustment (i.e., side-to-side adjustment) and/or elevation adjustment (i.e., up-and-down adjustment) to achieve a desired sight or reticle position.

In various examples, power source 80 can comprise hardware and/or software components. Power source 80 can supply power or energy to emitter system 30, or to any other component of sight system 10 that may require power (e.g., motion sensor 60, input device 70, processor 90, and/or memory device 95). Power source 80 can comprise, for example, a battery, electronic generator, and/or capacitor in electronic communication with such components. For example, a battery can be disposed in a battery housing at least partially within the body of the sight system and electronically coupled to the components that will receive power from the battery.

In various examples, motion sensor 60 can comprise hardware and/or software components (e.g., capable of storing, transmitting, and/or analyzing information). Motion sensor 60 can be electronically coupled to emitter system 30, power source 80, input device 70, processor 90, and/or memory device 95. Motion sensor 60 (i.e., motion detector) can be configured to detect movement of sight system 10. Motion sensor 60 can be configured to transmit signals to processor 90 based on the detected movement or nonmovement. Motion sensor 90 can be any suitable device configured to detect movement, such as an accelerometer, vibration sensor, ultrasonic motion sensor, microwave sensor, passive infrared motion sensor, proximity sensor, and/or the like. In various examples, motion sensor 90 can be a roll-ball switch (e.g., a micro-sized ball within a surface-mounted device), in which the position of the roll-ball can be detected at predetermined intervals (e.g., every millisecond). In response to detecting the roll-ball being in different positions at consecutive or adjacent intervals, for example, movement can be detected. As another example, in response to detecting the roll-ball being in the same position at consecutive or adjacent intervals, no movement (i.e., a lack of movement) can be detected. A processor (e.g., processor 90) can receive outputs or data from motion sensor 60, and the processor can determine if there was motion or a lack of motion based on the information received from motion sensor 60.

In various examples, motion sensor 60 can be coupled to emitter system 30 (physically and/or electronically). Motion sensor 60 can be electronically coupled in parallel with one of first emitter 33 and second emitter 36, and in series with the other of first emitter 33 and second emitter 36. For example, motion sensor 60 can be electronically coupled in parallel with first emitter 33 and in series with second emitter 36. In such embodiments, information or findings from or based on motion sensor 60 can affect second emitter 36, and not first emitter 33. For example, in response to detecting a lack of motion, an action on second emitter 36 can be taken, e.g., second emitter 36 can be disabled or turned off via the processor and/or motion sensor 60, such that the secondary reticle is no longer emitted or viewable by the user. In response to detecting motion, an action on second emitter 36 can be taken, e.g., second emitter 36 can be maintained (if the second emitter is on) or re-enabled (if the second emitter is off) via the processor and/or motion sensor 60, such that the secondary reticle is emitted or viewable by the user.

In various examples, input device 70 can comprise hardware and/or software components (e.g., capable of storing, transmitting, and/or analyzing information). Input device 70 can be in electronic communication with the other electronic components of sight system 10 (e.g., emitter system 30, motion sensor 60, power source 80, processor 90, and/or memory device 95). Input device 70 can be a physical or digital button, or any other device to allow a user to communicate with and/or provide commands to sight system 10 (e.g., to processor 90). In response to being selected, an input device 70 can produce an input signal received by a processor, which can command the processor to perform or facilitate performance of an operation. For example, input device 70 can be a digital button displayed on a touch screen on sight system 10 (e.g., on housing 20) which can be selected by tapping the screen, and/or input device 70 can be a physical button to input information. In various examples, an action performed by a user through sight system 10 can be input via an input device, communicated to sight system 10, and/or performed by a processor (e.g., processor 90).

In various examples, memory device 95 can comprise hardware and/or software components capable of storing, transmitting, and/or analyzing information. Memory device 95 can be in electronic communication with emitter system 30, motion sensor 60, input device 70, power source 80, and/or processor 90. Memory device 95 can be able to communicate, and/or share information, with emitter system 30, motion sensor 60, input device 70, power source 80, and/or processor 90. Memory device 95 can comprise instructions (e.g., instructions 97) for emitting light and/or images (e.g., a reticle(s)), changing images (e.g., changing reticle configurations), changing brightness of emitted light and/or images, and/or the like. Timer 98 comprised in memory device 95 can be utilized in operating sight system 10, as discussed herein. In various examples, instructions 97 and/or timer 98 can be comprised in one system, device, and/or component of sight system 10 and/or memory device 95, or the same can be separate components or combined with other components in any suitable configuration.

In various examples, memory device 95 can store program code and or instructions 97 executable by a processor (e.g., processor 90). Memory device 95 can also store other data such as emission data, image data (e.g., reticle configurations), event data, and/or timer data. Memory device 95 can be a tangible non-transitory computer-readable memory. In various examples, memory device 95 can include random access memory (RAM), which can include non-volatile RAM (NVRAM), magnetic RAM (MRAM), ferroelectric RAM (FeRAM), and other forms as commonly understood in the industry. In various examples, memory device 95 can include read only memory (ROM). In various embodiments, memory device 95 includes flash memory and/or EEPROM (electrically erasable programmable read only memory). It should be appreciated that, any other suitable magnetic, optical, and/or semiconductor memory can operate in conjunction with sight system 10.

In various examples, memory device 95 can comprise a processor(s) therein and/or utilize a processor in another component of sight system 10 (e.g., processor 90). The process in sight system 10 can comprise hardware and/or software components (e.g., capable of storing, transmitting, and/or analyzing information). The processor can be in electronic communication with emitter system 30, motion sensor 60, input device 70, power source 80, and/or memory device 95. The processor can be configured to cause the components of sight system 10 to interact with one another, to receive inputs from the user through an input device 70, perform or execute the functions, or instruct/facilitate the performance of functions, including, for example, changing images (e.g., changing reticle configurations), changing brightness of emitted light and/or images, enable or disabling an emitter(s), and/or the like. In various examples, each electronic component of sight system 10 can have a separate processor performing functions, or processor 90 can be located in one or more components of sight system 10, or processor(s) 90 can be a separate component of sight system 10.

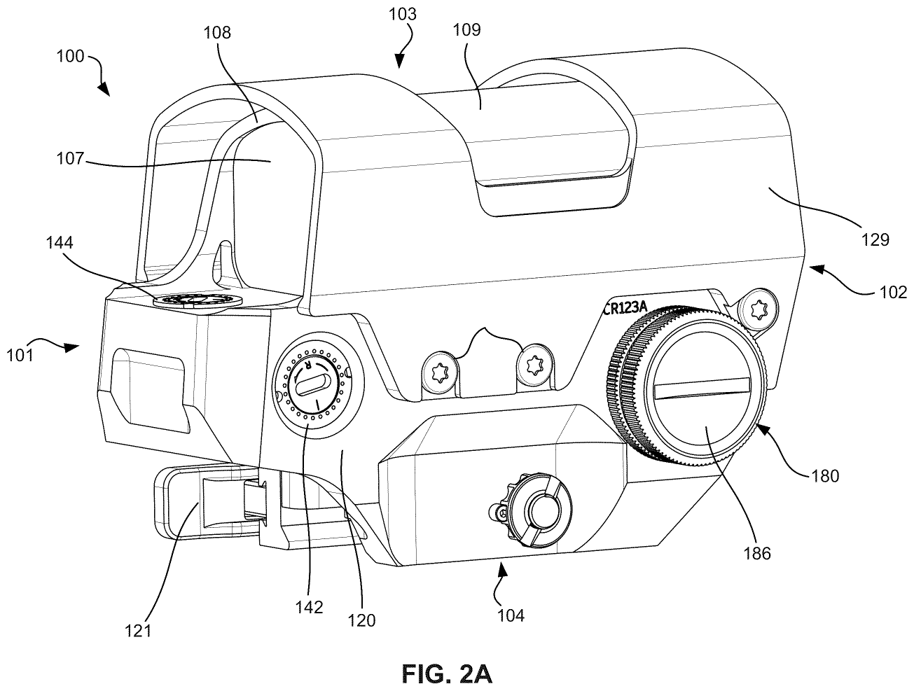

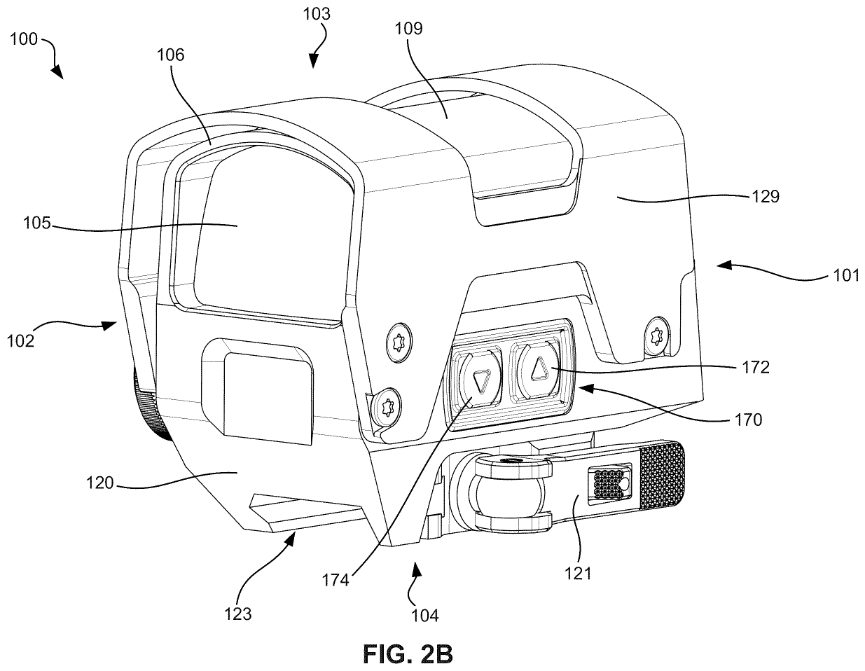

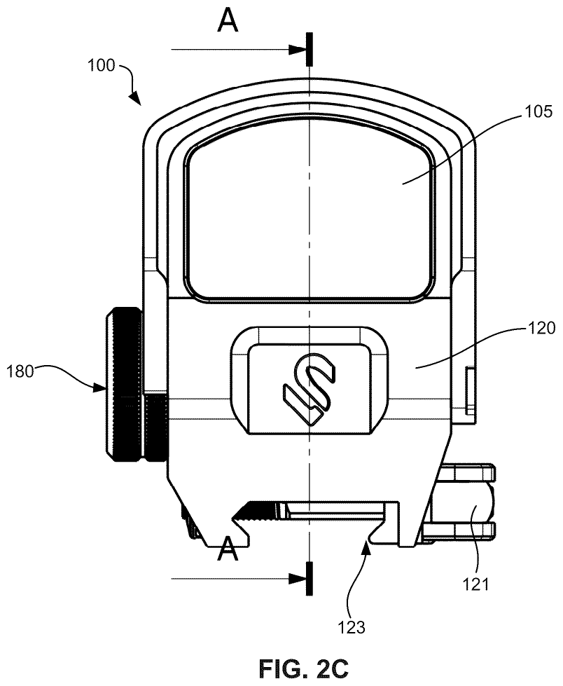

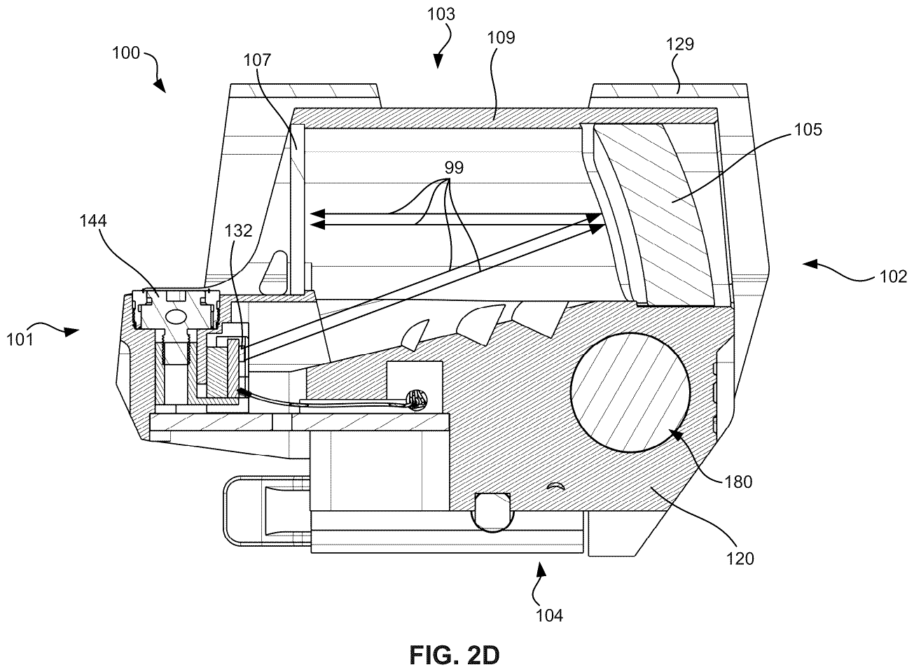

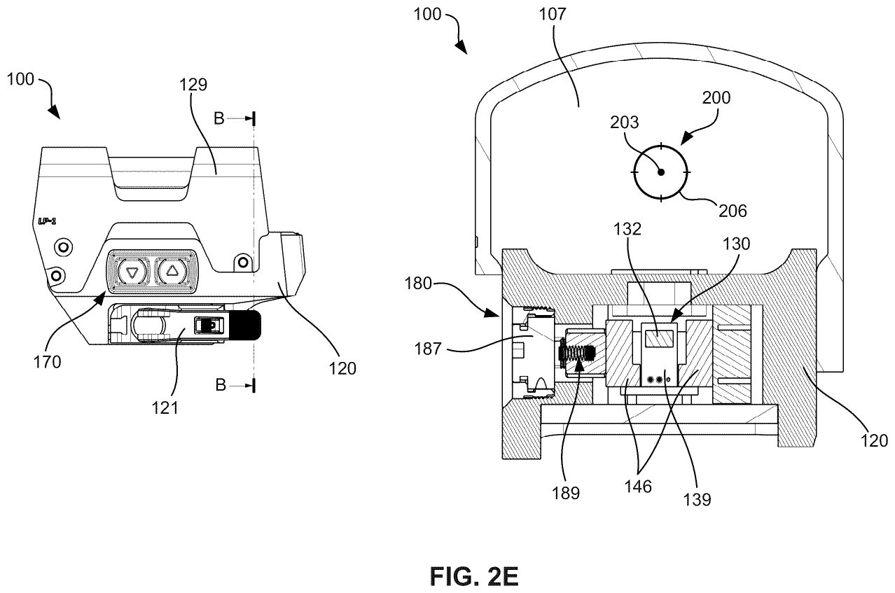

With additional reference to FIGS. 2A-2E, a sight system 100 is depicted, in accordance with various examples. Sight system 100 extends from and between an aft end 101 and a forward end 102 opposite aft end 101, and between a top end 103 and a bottom end 104 opposite top end 103. When coupled to a firearm or like device, aft end 101 can be more proximate to the rear or butt of the firearm (i.e., placed in the direction of recoil) relative to forward end 102. Forward end 102 which can be disposed more proximate the forward end or muzzle of the firearm. Bottom end 104 can be more proximate to an axis along which a projectile travels from the firearm or like device than top end 103.

Sight system 100 can comprise a housing 120 (an example of housing 20 discussed herein). Housing 20 can couple to and/or at least partially house various components of sight system 100.

Sight system 100 can comprise lens 105 (an example of lens 5 discussed herein) coupled to housing 120. Lens 105 can extend outwardly from a top end of housing 120.

Housing 120 can couple to and/or comprise an emitter system 130 (an example of emitter system 30 discussed herein). Emitter system 130 can comprise an emitter 132, which his configured to emit light therefrom to lens 105. The light emitted by an emitter system can be directly emitted to the lens, or such light can interact with one or more other components within a sight system before reaching the lens. Emitter can comprise any suitable light-producing device (e.g., a light, an LED, a laser, a laser diode, and/or the like). Emitter system 130 can comprise an emitter controller or processor board 139 (an example of processor 90 discussed herein). Controller board 139 can receive signals or inputs from switch 170 and its input devices and/or from motion sensor 160 (discussed further herein), and/or can cause emitter 132 to emit light and/or an image(s) (e.g., a reticle(s)) via one or more emitters. Controller board 139 can also electronically couple emitter 132 and motion sensor 160, and/or electronically couple emitter 132 and motion sensor 160 with switch 170 and/or power supply 180 (discussed further herein).

Lens 105 can be an at least partially transparent component (e.g., comprising glass, polymeric material, and/or the like) that presents a reticle(s) to a user and/or allows a user to look therethrough and view a reticle(s). Lens 105 reflective lens that is at least partially reflective, such that lens 105 reflects light emitted from emitter 132. Lens 105 can be an optical collimator that produces or presents a virtual image from the light emitted by emitter 132. With specific reference to FIG. 2D, emitter 132 can emit light 99, which is reflected by lens 105 toward aft end 101 of sight system 100 (toward the user's eye). Lens 105 can be disposed at an appropriate angle to facilitate the reflection of light 99 from emitter 132 to the user at aft end 101. Lens 105 can produce an image from light 99 from emitter 132 made up of collimated light (i.e., nearly parallel light). Thus, reflected light 99 can be substantially parallel with the axis of sight system 100, an axis along which sight system 100 is coupled to a firearm or like device, and/or an axis of a firearm barrel to which sight system 100 is coupled. So, the user can utilize the image (e.g., a reticle) produced by light 99 from emitter 132 and reflected from lens 105 as an aiming point for firing the firearm or like device.

In various examples, sight system 100 can comprise an ocular lens 107. Ocular lens 107 may not reflect light, but can allow light 99 to pass therethrough for viewing by the user. Ocular lens 107 can be disposed aft of lens 105, which can be configured to provide protection for the components of sight system 100 aft of lens 105, provide protection for lens 105 itself, magnify the image reflected from lens 105, and/or provide any other suitable function. In various examples, a sight system 100 may not include a lens other than the lens for presenting the reticle(s) (e.g., a reflective lens for reflecting the emitted image).

In various examples, a sight system can comprise a lens frame for each lens. For example, sight system 100 can comprise lens frame 106 at least partially surrounding lens 105, and/or lens frame 108 least partially surrounding ocular lens 107. The lens frames can be integral and/or monolithic components of housing 120, or the lens frames can be coupled to housing 120. In various examples, a sight system can comprise an emission enclosure spanning at least between the emitter system and the lens or other components reflecting the emitted light. For example, emission enclosure 109 of sight system 100 can span from and between emitter system 130 and lens 105, and between ocular lens 107 and lens 105. Emission enclosure 109 can be configured to at least partially enclose or shade the emission 99 from emitter system 130 to lens 105, and the reflection of light 99 to the user. Such a configuration can enhance visibility of the emitted image or reticle and/or protect the enclosed and/or covered components. To further protect the lenses and/or other components of a sight system, the sight system can comprise a protective hood coupled to the housing (e.g., protective hood 129 coupled to housing 120).

Emitter system 130 can comprise one or more emitters in emitter 132 (e.g., two emitters, such as first emitter 33 and second emitter 36, discussed herein). The emitters in emitter 132 can be discrete from one another. For example, a first emitter and second emitter can be electrically in parallel with one another, such that each emitter can be controlled (e.g., enabled or disabled, or turned on and off, or brightened or dimmed) separately. Each emitter can emit light, which will be directed (either directly or indirectly) to a lens. Each emitter of emitter 132 can emit light in an image to lens 105 for reflection. For example, a first emitter can emit a first or primary reticle, and a second emitter can emit a second or secondary reticle. Together, the primary and secondary reticles can create a complete reticle configuration that a user can use as an aiming device. For example, with specific reference to FIG. 2E, the first emitter of emitter 132 can emit primary reticle 203, and the second emitter of emitter 132 can emit secondary reticle 206, which together form complete reticle 200. Primary reticle 203 can comprise a central reticle or a dot reticle (i.e., an aiming point reticle), which can provide a more precise aiming point relative to secondary reticle 206. Secondary reticle 206 can comprise an open reticle or perimeter reticle (e.g., a reticle having light in at least a partial ring, circular, oval, or square perimeter shape, or any other suitable shape, having an open center, such that the user can see through the center of the secondary reticle). An open or perimeter reticle (e.g., secondary reticle 206) can at least partially surround a dot or aiming point reticle (e.g., primary reticle 203). An open or perimeter reticle can be an ancillary reticle relative to a dot or aiming reticle. Primary reticle 203 can require or consume less energy from a power source than secondary reticle 206. That is, a central or dot reticle can require or consume less energy from a power source than a perimeter or open reticle, because the central or dot reticle requires less emitted and/or reflected light.

Sight system 100 can comprise a plurality of reticle configurations offered to the user. For example, a primary reticle configuration can comprise the primary reticle emitted and/or presented without the secondary reticle. A secondary reticle configuration can comprise the secondary reticle emitted and/or presented without the primary reticle. A complete reticle configuration can comprise the primary and secondary reticles emitted and/or presented together at the same time.

Sight system 100 can have a switch 170 having buttons 172 and 174 (examples of input devices 70 discussed herein). First button 172 can comprise an “up” arrow, indicating that if the user presses first button 172, the brightness of the light emitted by emitter 132 (for the primary and/or second reticle) will increase in response. In response to selection of first button 172, the processor in sight system 100 (e.g., processor 90) can brighten the presented reticle(s). Second button 174 can comprise a “down” arrow, indicating that if the user presses second button 174, the brightness of the light emitted by emitter 132 (for the primary and/or second reticle) will decrease in response. In response to selection of second button 174, the processor in sight system 100 (e.g., processor 90) can dim the presented reticle(s).

In response to a user pressing both buttons 172 and 174 at the same time, sight system 100 can change the reticle configuration (i.e., cycle between reticle configurations). For example, the processor can detect that both buttons 172 and 174 are depressed at the same time, and in response, the processor can cause emitter system 130 to change the reticle configuration. The reticle configurations can have a cycle or order in which they are changed. For example, with the complete reticle configuration being emitted and/or presented, in response to both buttons 172 and 174 being selected at the same time, the processor can change the reticle configuration to the next configuration in the order, for example the primary reticle configuration (thus, the processor can disable the second emitter and/or otherwise render the secondary reticle nonviewable). In response to subsequently detecting both buttons 172 and 174 being selected at the same time, the processor can change the reticle configuration to the next configuration in the order, for example the secondary reticle configuration (thus, the processor can disable the first emitter and/or render the primary reticle nonviewable and enable the second emitter and present the secondary reticle). In response to subsequently detecting both buttons 172 and 174 being selected at the same time, the processor can change the reticle configuration to the next configuration in the order, for example the complete reticle configuration, or turn off emitter system 130 (e.g., after all reticle configurations have been presented in the cycle or order).

Sight system 100 can have an adjustment system 140 (an example of adjustment system 40 discussed herein). Adjustment system 140 can be configured to adjust the position of the reticle(s) emitted and/or presented by emitter system 130 (e.g., to sight in sight system 100 on a firearm). Adjustment system 140 can comprise an emitter tray 145. Emitter system 130 can be disposed at least partially within and/or coupled to emitter tray 145. Emitter tray 145 can comprise tray arms 146 between which emitter 132 can be disposed and coupled. Tray arms 146 can be configured to secure and/or retain emitter 132 in place within emitter tray 145 to avoid unwanted or unintentional movement of emitter 132 and/or the resulting reticle(s).

An adjustment system can comprise an adjustment device to adjust the emitter and/or reticle(s) for windage and/or an adjustment device to adjust the emitter and/or reticle(s) for elevation. In various examples, there can be one adjustment device to adjust windage and elevation. Adjustment device 140 can comprise windage adjustment screw 142 and elevation adjustment screw 144. Windage adjustment screw 142 can be turned or rotated (or otherwise moved) to adjust the position of the presented reticle on lens 105 along a first axis (e.g., side-to-side). Elevation adjustment screw 144 can be turned or rotated (or otherwise moved) to adjust the position of the presented reticle on lens 105 along a second axis that is substantially perpendicular to the first axis (e.g., up-and-down). Adjustment screws 142 and 144 can be coupled to emitter tray 145 and/or emitter system 130 in any suitable manner to effectuate the desired adjustment of emitter 132 and the resulting reticle(s). Adjustment screws 142 and 144 can be disposed in and/or coupled to housing 120 in any suitable position or manner.

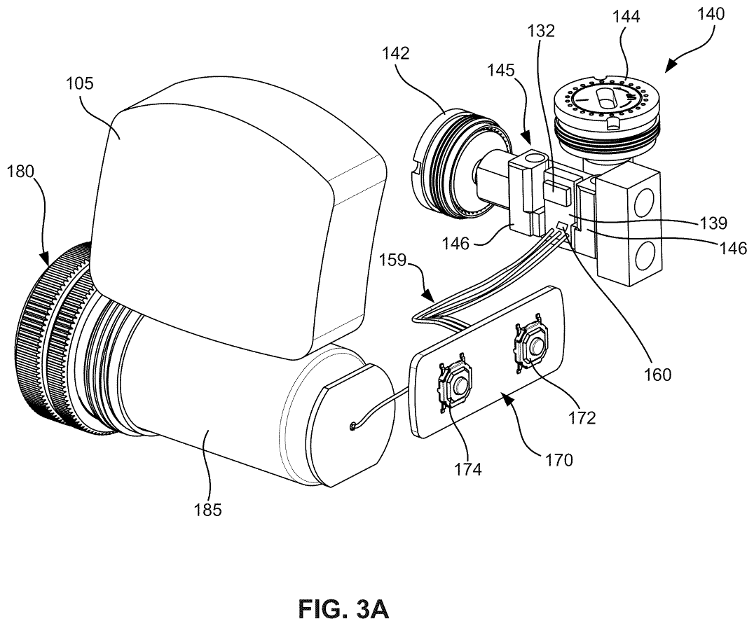

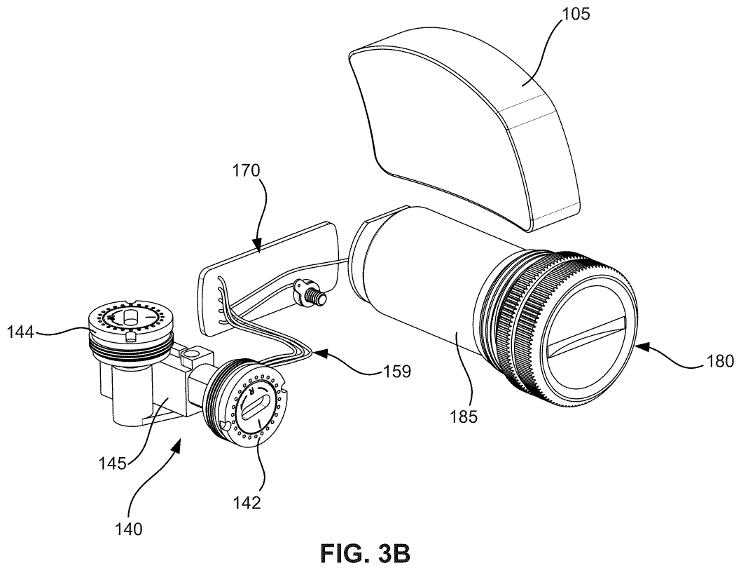

With additional reference to FIGS. 3A and 3B, the electronic components of sight system 100, along with adjustment system 140 and lens 105, are depicted in accordance with various examples. Sight system 100 can have a motion sensor 160. Motion sensor can be disposed in emitter system 130 and/or coupled thereto (e.g., coupled to controller board 139). Motion sensor 160 can be configured to detect motion of sight system 100 (e.g., in response to the coupled firearm being used or moved, for example, in combat). Motion sensor 160 can be configured to transmit signals or information indicating position and/or motion, and a processor (e.g., controller board 139) can interpret such information to determine if there is movement. In various examples, motion sensor 160 can determine if there is movement (e.g., via a process comprised in motion sensor 160), and/or transmit a signal or information indicating movement or a lack of movement to a processor to perform a resulting operation.

As discussed herein, motion sensor 160 can be any suitable device configured to detect movement, such as an accelerometer, vibration sensor, ultrasonic motion sensor, microwave sensor, passive infrared motion sensor, proximity sensor, a roll-ball switch, and/or the like. Motion sensor 160 can be coupled in parallel with a first emitter of emitter 132 and in series with a second emitter of emitter 132. As such, motion sensor 160 can affect the second emitter (e.g., disable or turn off, for example by preventing current flowing to, the second emitter, or enable or turn on, for example by allowing current to flow to, second emitter), and may not affect the first emitter.

Sight system 100 can have a power supply 180. Power supply 180 can be configured to supply power (e.g., current) to one or more electronic components of sight system 100 (e.g., switch 170, emitter system 130, motion sensor 160, a processor, a memory device, and/or the like). Power supply 180 can comprise a battery 187 disposed in a battery housing 185. The cap 186 of battery housing can be screwed off, or otherwise decoupled from battery housing 185, such that battery 187 can be removed and/or replaced. Positive contact can be maintained on battery 187 via spring 189 to facilitate the maintenance of an electrical circuit such that current can flow from power source 185 to other components of sight system 100, e.g., via wiring 159.

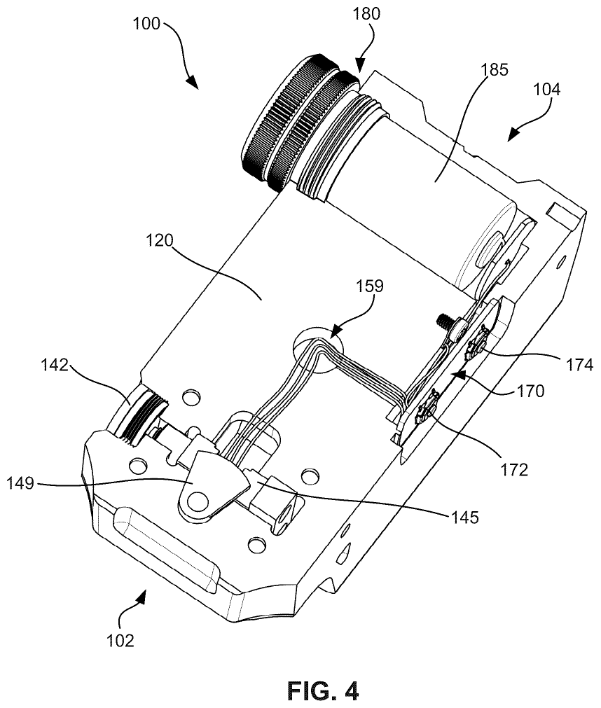

FIG. 4 depicts the various components of sight system 100 (e.g., power supply 180, switch 170, wiring 159, and/or adjustment system 140) disposed in housing 120 (a cross-section of housing 120 is displayed in FIG. 4 to illustrate the position of various components disposed therein). Adjustments system 140 can be retained within its respective cavity in housing 120 via a retention tab 149. Retention tab 149 can pivot to block adjustment system 140 from exiting its cavity within housing 120, and/or to allow adjustment system 140 to be removed therefrom or replaced therein.

Sight system 100 can comprise a coupling cavity 123 configured to facilitate the coupling of sight system 100 to a firearm (e.g., to a rail on a firearm). Coupling cavity 123 can be defined by the shape of housing 120 on bottom end 104, which can be complementary to the shape of a coupling point on a firearm (e.g., a rail). Housing 120 can be disposed onto a firearm rail, such that a portion of the firearm rail is disposed within coupling cavity 123. Coupling lever 121 can be rotated or otherwise translated to loosen or tighten fastening of housing 120 to the firearm rail. For example, coupling lever 121 can be disposed in a closed position (as depicted in FIG. 2B) to tighten the grasp of the firearm rail within coupling void 123, and coupling lever 121 can be rotated about a hinge or like pivot point to loosen the grasp of the firearm rail within coupling void 123 (e.g., to decouple housing 120 from the firearm rail).

In various examples, in response to detecting a lack of movement of sight system 100 for a predetermined nonmovement duration, at least a portion of the presented reticle can be disabled or turned off, or otherwise rendered unviewable, to save power and battery life. However, in sight systems that disable the entire reticle in response to a period of nonmovement, the user must await reactivation of the entire reticle in response to moving the sight system. Even though reactivation may take place relatively quickly (e.g., less than a second), such a time period can be critical in a combat situation or other time-sensitive state. Further, if the motion detection function fails with the entire reticle disabled due to nonmovement, the user would be forced to try to manually reactivate the reticle, for example, by pushing one or more buttons on the sight system (e.g., by pressing first and second buttons 172 and 174 at the same time), thus delaying the appearance of a reticle or aiming point.

This disclosure allows the ability to disable a portion of a reticle (e.g., a portion of complete reticle configuration 200) while leaving another portion continually presented. For example, in response to detected nonmovement for a predetermined duration (i.e., a nonmovement duration), a portion of the reticle can be disabled (i.e., rendered unviewable) while continuing to maintain another portion of the reticle. Thus, the disabled reticle can aid in conserving battery life, while an aiming point (the maintained reticle portion) remains continuously available, providing a battle-ready aiming point. With the continuous reticle presence, the disclosed system guards against the consequences of a malfunctioning motion sensor or other component of sight system 100 needed to reactivate the disabled reticle. Further, the redundant reticle component (e.g., a perimeter reticle), which can provide utility to a firearm user in addition to the maintained reticle component (e.g., a dot reticle providing an aiming point), can be reactivated in response to movement of sight system 100 and/or the firearm coupled thereto to further facilitate aiming.

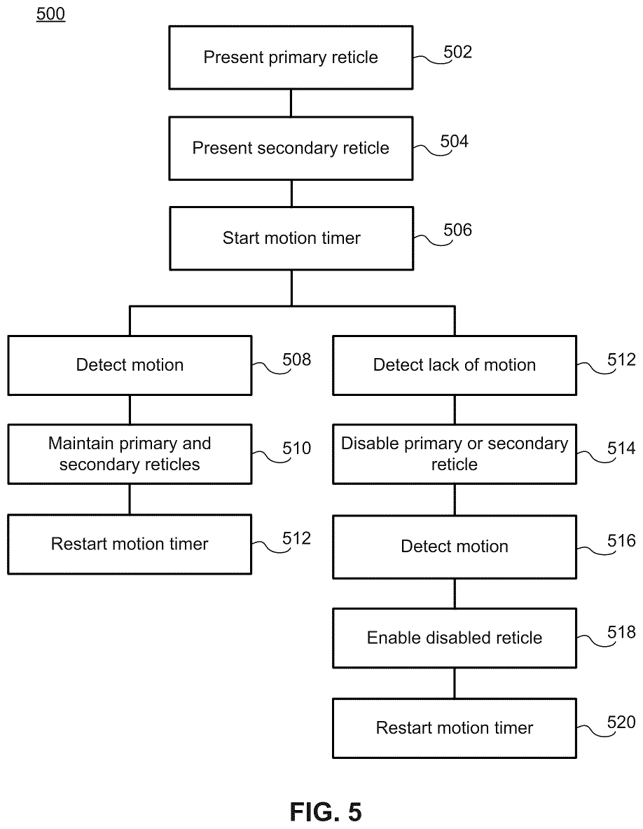

With additional reference to FIG. 5, a method 500 of reticle presentation on a sight system (e.g., sight system 100) is depicted, in accordance with various examples. With reference to the embodiment depicted in FIGS. 2A-4, a primary reticle can be presented (step 502) from a first emitter (i.e., the light presenting the first reticle can be emitted). The first emitter can be comprised in emitter 132. The first emitter can emit light in a first image, which can be primary reticle 203 (e.g., a dot or other aiming point reticle), which is reflected from lens 105 and presented to the user. A secondary reticle can be presented (step 504) from a second emitter (i.e., the light presenting the second reticle can be emitted). The second emitter can be comprised in emitter 132. The second emitter can emit light in a second image, which can be secondary reticle 206 (e.g., a ring or other perimeter reticle), which is reflected from lens 105 and presented to the user. Thus, in response to steps 502 and 504 being performed without disabling of either reticle, the displayed reticle can be in the complete reticle configuration comprising both primary and secondary reticles. It should be understood that, in various examples, the primary reticle can be the perimeter reticle and the secondary reticle can be the dot or aiming point reticle—the primary or secondary reticles can be any suitable reticle shape, style, or configuration. Current can be supplied to emitter 132 from power supply 180 to allow presentation of primary reticle 203 and second reticle 206. A processor (e.g., processor 139 or 90) can enable the first and second emitters to emit light for primary reticle 203 and second reticle 206. Such emission can be in response to the processor receiving an input instructing the processor to turn on emitter 132 and/or change the reticle configuration to the complete reticle configuration.

In various embodiments, the processor can start a motion timer (e.g., timer 98) (step 506). The motion timer can be for a predetermined nonmovement duration, which can be any suitable duration, such as five seconds, 10 seconds, 30 seconds, about 60 seconds, about 90 seconds, about 120 seconds, about 180 seconds, about 240 seconds, about 300 seconds, and/or the like (wherein “about” in this context means plus or minus 30 to 60 seconds), during which both primary reticle 203 and secondary reticle 206 can be maintained (i.e., presented to the user for aiming). In response to motion being detected (step 508), primary reticle 203 and secondary reticle 206 can be maintained (step 510), and the motion timer can be restarted (step 512), effectively returning to step 506.

As discussed herein, motion sensor 160 can be any suitable device for sensing movement. For example, motion sensor 160 can detect a position of itself, sight system 100, and/or the surrounding environment at periodic intervals (e.g., every 1-5 milliseconds). In response to the detected positions of two consecutive intervals being different, the processor and/or motion sensor 160 can detect movement, thus, maintaining presentation of primary reticle 203 and secondary reticle 206, and/or restarting the motion timer.

In response to detecting a lack of motion (step 512), e.g., for the predetermined nonmovement duration, a portion of the present reticle configuration can be disabled (e.g., automatically by the processor). For example, primary reticle 203 or secondary reticle 206 can be disabled (step 514) in response to detecting a lack of movement for the predetermined nonmovement duration. The other reticle can be maintained and presented to the user. Disabling a reticle can comprise the processor preventing current from reaching the respective emitter (e.g., breaking an electrical circuit thereto). Detecting a lack of motion for the predetermined nonmovement duration can comprise motion sensor 160 detecting nonmovement for every interval during the predetermined nonmovement duration. The processor (e.g., included in motion sensor 160 and/or a separate processor) can determine nonmovement for the predetermined nonmovement duration based on motion information from motion sensor 160, and in response, disable primary reticle 203 or secondary reticle 206. For example, secondary reticle 206 can be disabled, and primary reticle 203 can be maintained. Thus, if secondary reticle 206 does not reactivate in response to movement of sight system 100 (e.g., because of a malfunction of motion sensor 160 or the like), the user of the firearm with sight system 100 will still have primary reticle 203 as a sight and aiming point.

In various examples, in response to detecting a lack of motion for the predetermined nonmovement duration, the reticle having the greater power requirement (e.g., requiring the greater light emission and/or current) can be disabled, leaving the reticle with the lesser power requirement. Accordingly, primary reticle 203 being a dot or aiming point reticle can require less light and current than secondary reticle 206 (a ring or perimeter reticle). Thus, disabling secondary reticle 206 and maintaining primary reticle 203 in response to nonmovement can conserve more energy than disabling primary reticle 203 and maintaining secondary reticle 206.

In response to a reticle being disabled for nonmovement, motion sensor can continue to monitor for motion. In response to detecting motion (step 516), the disabled reticle can be (re) enabled (step 518), for example, automatically by the processor. Enabling a reticle can comprise the processor allowing current to reach the respective emitter (e.g., completing an electrical circuit thereto). Thus, in response to detecting motion (any motion, e.g., motion sensor 160 detecting different positions during two consecutive intervals), secondary reticle 206 can be reenabled. In response to detecting motion and/or reenabling the disabled reticle, the motion timer can be restarted (step 520) (by the processor), thus effectively returning to step 506 and proceeding therefrom.

The structure of sight system 100 and its components allows the functionality described herein. Emitter 132 can comprise multiple, separate emitters, each emitting a different emission and/or reticle (or a portion of a complete reticle). At least two emitters are electronically coupled in parallel with one another. Additionally, at least one emitter is not electronically coupled in series with motion detector 160. Thus, motion detector 160 or any information determined thereby or therefrom may not affect emission of the emitter(s) not coupled in series therewith (such emitter can be coupled in parallel with motion sensor 160). Also, a processor(s) can control (e.g., disable/turn off or enable/turn on, or brighten or dim) at least one emitter separate from the other emitter(s), which may be facilitated by such emitters being electronically coupled in parallel. Any or all steps of method 500 can be executed and/or facilitated by one or more processors, as discussed herein.

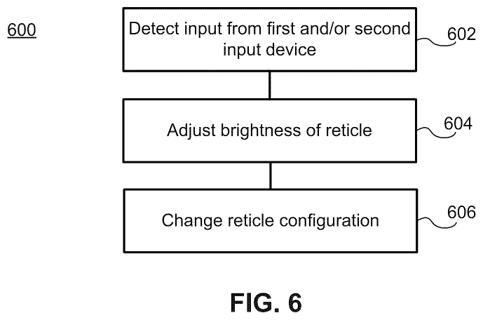

With additional reference to FIG. 6, a method 600 of changing a reticle on a sight system (e.g., sight system 100) is depicted, in accordance with various examples. A sight system can have a catalog of, or instructions for, different reticle configurations (e.g., wherein each configuration employs a different combination of reticle components). The reticle configurations can be arranged in an order, and the instructions associated therewith can be stored in a memory device (e.g., memory device 95). For example, sight system 100 can comprise reticle configurations comprising a primary reticle configuration in which only primary reticle 203 is emitted and/or presented (and secondary reticle 206 is disabled or otherwise not presented), a secondary reticle configuration in which only secondary reticle 206 is emitted and/or presented (and primary reticle 203 is disabled or otherwise not presented), and a complete reticle configuration in which both primary reticle 203 and secondary reticle 206 are emitted and presented.

An input can be detected (step 602) by the processor of sight system 100. For example, a user can press one or more of buttons 172 and 174. In response to receiving an input that only one of buttons 172 and 174 is pressed at one time, the processor can adjust the brightness of the displayed reticle (step 604) accordingly. For example, in response to receiving an input that first button 172 was or is pressed, the processor can increase the brightness of the light emitted by emitter 132 (for the primary and/or second reticle). In response to receiving an input that second button 174 was or is pressed, the processor can decrease the brightness of the light emitted by emitter 132 (for the primary and/or second reticle).

In response to detecting that both buttons 172 and 174 are pressed at the same time (e.g., for a predetermined reticle duration), the processor can change the reticle configuration (step 606). For example, between the primary, secondary, and complete reticle configurations, the processor can cause emitter 132 to emit the next reticle configuration in an order of reticle configurations in response to detecting both buttons 172 and 174 being pressed at the same time. In response detecting that both buttons 172 and 174 are pressed at the same time for a shutoff duration, the processor can turn off sight system 100 such that emitter 132 is disabled and no reticle is presented.

As discussed herein, the primary and secondary reticles can comprise any suitable shape or configuration, and are not limited to those discussed herein. In various examples, a primary reticle can be a reticle that is maintained in response to detecting a lack of motion for a nonmovement duration, and a secondary reticle can be a reticle that is disabled in response to detecting a lack of motion for a nonmovement duration (and then re-enabled in response to subsequently detecting motion).

As depicted and discussed in relation to FIGS. 2A-2E, sight system 100 is a reflector sight system. However, it should be understood that this disclosure can be applied to any electronic sight system (e.g., a holographic sight system and/or the like). In such systems, similar components and methods can be employed to disable, block, or turn off, or otherwise render unviewable, light (e.g., an emitter) configured to illuminate or otherwise present a secondary reticle in response to detecting nonmovement for a predetermined nonmovement duration. For example, a first emitter can emit light configured to illuminate a primary reticle, and a second emitter (separate from the first emitter) can emit light configured to illuminate a secondary reticle. In response to detecting nonmovement for a predetermined nonmovement duration, light configured to illuminate the secondary reticle can be blocked, disabled, turned off, or otherwise rendered unviewable to a user (e.g., by disabling the second emitter).

The detailed description herein is presented for purposes of illustration only and not of limitation. For example, the steps recited in any of the method or process descriptions may be executed in any combination and/or order and are not necessarily limited to the order or combination presented. As another example, the components of a sight system can be disposed and/or coupled in any suitable combination or arrangement. Furthermore, any reference to singular includes plural examples, and any reference to more than one component or step may include a singular component or step. Also, any reference to attached, fixed, connected, or the like may include permanent, removable, temporary, partial, full, and/or any other possible attachment option. Additionally, any reference to without contact (or similar phrases) may also include reduced contact or minimal contact.

All ranges may include the upper and lower values, and all ranges and ratio limits disclosed herein may be combined. Unless specifically stated otherwise, references to “a,” “an,” and/or “the” may include one or more than one, and references to an item in the singular may also include the item in the plural. Unless otherwise indicated, the terms “first,” “second,” etc., and/or “primary,” “secondary,” etc., are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item. Further, reference to, e.g., a “first” item and a “second” item does not mean that there are no intervening items, and such intervening items may be present.

Systems, methods, and apparatus are provided herein. In the detailed description herein, references to “one example”, “an example”, “various examples”, etc., indicate that the example described may include a particular feature, structure, or characteristic, but every example may not necessarily include the particular feature, structure, or characteristic. Moreover, when a particular feature, structure, or characteristic is described in connection with an example, it is within the knowledge of one skilled in the art to affect such feature, structure, or characteristic in connection with other examples whether or not explicitly described. After reading the description, it will be apparent to one skilled in the relevant art(s) how to implement the disclosure in the examples herein.

Unless specifically stated otherwise, as apparent from the discussion herein, it is appreciated that throughout this specification, discussions utilizing terms such as “processing,” “computing,” “calculating,” “determining” or the like refer to actions or processes of a processor, such as a processor on a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or display screens of the special purpose computer or similar special purpose electronic computing device.

The systems and methods can be described herein in terms of functional block components, screen shots, optional selections and various processing steps. It should be appreciated that such functional blocks can be realized by any number of hardware and/or software components configured to perform the specified functions. For example, the system can employ various integrated circuit components, e.g., memory elements, processing elements, logic elements, look-up tables, and the like, which can carry out a variety of functions under the control of one or more microprocessors or other control devices. Similarly, the software elements of the system can be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system can employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O′Reilly & Associates (1998); (3) “Cryptography & Network Security: Principles & Practice” by William Stallings, published by Prentice Hall; all of which are hereby incorporated by reference.

The system and method is described herein with reference to screen shots, block diagrams and flowchart illustrations of methods, apparatus (e.g., systems), and computer program products according to various examples. It will be understood that each functional block of the block diagrams and the flowchart illustrations, and combinations of functional blocks in the block diagrams and flowchart illustrations, respectively, can be implemented by computer program instructions.

As used herein, “transmit,” “transfer,” and/or the like can include sending electronic data from one system component to another via electronic or network connection. Additionally, as used herein, “data,” “information,” “signals,” and/or the like can include encompassing information such as commands, queries, files, data for storage, and the like in digital or any other form.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific examples. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone can be present in an example, B alone can be present in an example, C alone can be present in an example, or that any combination of the elements A, B and C can be present in a single example; for example, A and B, A and C, B and C, or A and B and C. Although the disclosure includes a method, it is contemplated that it can be embodied as computer program instructions on a tangible computer-readable carrier, such as a magnetic or optical memory or a magnetic or optical disk. All structural, chemical, and functional equivalents to the elements of the above-described various examples that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

Accordingly, functional blocks of the block diagrams and flowchart illustrations support combinations of components and/or processes for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A sight system, comprising:
a housing;
a lens coupled to the housing;
a power source disposed at least partially in the housing;
a switch in electronic communication with the power source;
an emitter system disposed at least partially within the housing and in electronic communication with the switch, the emitter system comprising:
a first emitter configured to present a primary reticle visible via the lens; and
a second emitter configured to present a secondary reticle visible via the lens,
wherein the first emitter and the second emitter are electronically in parallel with one another; and
a motion sensor electronically coupled with the second emitter,
wherein, in response to a predetermined nonmovement duration passing without the motion sensor detecting movement, the sight system is configured to disable the second emitter and maintain the first emitter to continue to present the primary reticle.

2. The sight system of claim 1, wherein the emitter system comprises a plurality of reticle configurations, comprising:
a complete reticle configuration comprising the primary reticle and the secondary reticle visible via the lens;
a primary reticle configuration comprising the primary reticle visible via the lens without the secondary reticle; and
a secondary reticle configuration comprising the secondary reticle visible via the lens without the primary reticle.

3. The sight of system claim 2, wherein the switch comprises a first input device and a second input device.

4. The sight system of claim 3, wherein in response to the first input device and the second input device being activated at the same time, the sight system is configured to change from one reticle configuration to another reticle configuration of the plurality of reticle configurations.

5. The sight system of claim 1, further comprising an emitter tray in which the emitter system is disposed within the housing.

6. The sight system of claim 5, further comprising:
a windage adjustment screw coupled to the emitter tray; and
an elevation adjustment screw coupled to the emitter tray,
wherein in response to moving the windage adjustment screw, the emitter tray moves along a first axis, and
wherein in response to moving the elevation screw, the emitter tray moves along a second axis that is substantially perpendicular to the first axis.

7. A sight system, comprising:
a lens; and
an emitter system, comprising:
a first emitter configured to present a primary reticle via the lens; and
a second emitter configured to present a secondary reticle via the lens,
wherein the first emitter and the second emitter are electronically in parallel with one another;
a motion sensor electronically coupled to the second emitter;
a processor operably connected to the first emitter, the second emitter, and the motion sensor; and
a tangible non-transitory computer readable memory configured to communicate with the processor, the tangible non-transitory computer readable memory having instructions stored thereon that, in response to execution by the processor causes the processor to perform operations comprising:
enabling, by the processor, the first emitter and the second emitter such that the primary reticle and the secondary reticle are visible via the lens;
starting, by the processor, a timer for a predetermined nonmovement duration;
detecting, by the processor and the motion sensor, a lack of motion for the predetermined nonmovement duration; and
in response to the detecting the lack of motion, disabling, by the processor, one of:
the first emitter such that the primary reticle is not presented, or
the second emitter such that the secondary reticle is not presented.

8. The sight system of claim 7, wherein the operations further comprise maintaining, by the processor, an emission from the other of the first emitter and the second emitter.

9. The sight system of claim 7, wherein the operations further comprise:
detecting, by the processor and the motion sensor, a movement; and
in response to the detecting the movement, enabling, by the processor, the disabled emitter such that both of the primary reticle and the secondary reticle are visible via the lens.

10. The sight system of claim 7, wherein the operations further comprise, prior to the detecting a lack of motion:
detecting, by the processor and the motion sensor, a movement within the predetermined nonmovement duration; and
restarting, by the processor, the timer for the predetermined nonmovement duration in response to detecting the movement.

11. The sight system of claim 7, wherein the primary reticle is a dot reticle and wherein the secondary reticle is a perimeter reticle configured to at least partially surround the dot reticle.

12. The sight system of claim 7, further comprising a switch in electrical communication with the emitter system, wherein the switch comprises a first button and a second button.

13. The sight system of claim 12, wherein the operations further comprise:
detecting, by the processor, the first button and the second button being pressed at the same time; and
changing, by the processor, a reticle configuration produced by the emitter system.

14. The sight system of claim 13, wherein the processor changes the reticle configuration between a plurality of reticle configurations in response to detecting the first button and the second button being pressed at the same time, wherein the plurality of reticle configurations comprises:
a complete reticle configuration comprising the primary reticle and the secondary reticle visible via the lens;
a primary reticle configuration comprising the primary reticle visible via the lens without the secondary reticle; and
a secondary reticle configuration comprising the secondary reticle visible via the lens without the primary reticle.

15. The sight system of claim 14, wherein in response to a complete reticle configuration being emitted and the detecting the first button and the second button being pressed at the same time, the operations further comprise:
disabling, by the processor, one of:
the first emitter such that the primary reticle is not presented, or
the second emitter such that the secondary reticle is not presented.

16. The sight system of claim 7, wherein the motion sensor is electronically in series with the second emitter and electronically in parallel with the first emitter.

17. A method, comprising:
enabling, by a processor, a first emitter and a second emitter of a sight system, wherein the first emitter presents a primary reticle via a lens and the second emitter presents a secondary reticle via the lens;
starting, by the processor, a timer for a predetermined nonmovement duration;
detecting, by the processor and a motion sensor, a lack of motion for the predetermined nonmovement duration; and
in response to the detecting the lack of motion, disabling, by the processor, one of:
the first emitter such that the primary reticle is not presented, or
the second emitter such that the secondary reticle is not presented.

18. The method of claim 17, further comprising maintaining, by the processor, an emission from the other of the first emitter and the second emitter.

19. The method of claim 17, further comprising:
detecting, by the processor and a motion sensor, a movement; and
in response to the detecting the movement, enabling, by the processor, the disabled emitter of the first emitter and the second emitter such that the primary reticle and the secondary reticle are visible via the lens.

20. The method of claim 17, further comprising, prior to the detecting a lack of motion:
detecting, by the processor and the motion sensor, a movement within the predetermined nonmovement duration; and
in response to the detecting the movement, restarting, by the processor, the timer for the predetermined nonmovement duration.
